(19) United States
(12) Patent Application Publication
(10) Pub. No.: US 2007/0294692 A1
(43) Pub. Date: Dec. 20, 2007

(54) Task Assignment Among Multiple Devices

(75) Inventors: Feng Zhao, Issaquah, WA (US); Jie Liu, Sammamish, WA (US); Zoe Abrams, Palo Alto, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/424,801

(22) Filed: Jun. 16, 2006

(51) Int. Cl. G06F 9/46

(52) U.S. Cl. 718/102

(57) ABSTRACT

A procedure identifies multiple objects or processes to be monitored and identifies multiple devices to monitor the multiple objects or execute the multiple processes. The procedure continues by identifying multiple tasks to be executed by the multiple devices and predicting a trajectory for each of the multiple objects. A determination is made regarding which device should be executing each of the multiple tasks based on the predicted trajectory for each of the multiple objects.

### BACKGROUND

In certain situations, it is important to manage the assignment of tasks to particular computing devices in a network of multiple computing devices. A task is an abstraction of a computational agent or data that is hosted by the computing devices. For example, in an object tracking scenario, a task represents a mobile tracking agent, such as an object location update computation. Multiple computing devices (such as motion sensors) monitor the position and movement of one or more objects. In this object tracking scenario, tasks run on the computing devices, which can receive sensor data related to the object of interest (e.g., the object being tracked). As the object moves, it typically moves closer to certain computing devices and farther away from other computing devices. Thus, the particular computing device responsible for tracking an object changes over time.

Due to communication, processing, and/or memory constraints, a particular computing device can host a limited number of tasks at the same time. Although tasks can be migrated among computing devices, this migration typically has certain costs, such as energy consumption and deterioration of quality of service. Thus, it is desirable to minimize the migration of tasks among computing devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The systems and methods described herein identify multiple objects (such as vehicles, people, packages, and the like) to be monitored and identify multiple devices to monitor the multiple objects. The described systems and methods also identify multiple tasks to be executed by the multiple devices, and predict a trajectory for each of the multiple objects. This trajectory information is used to determine which device should be executing each of the multiple tasks. Similar techniques may be used to monitor and reassign multiple tasks associated with different processes and/or data.

### BRIEF DESCRIPTION OF THE DRAWINGS

Similar reference numbers are used throughout the figures to reference like components and/or features.

FIG. 1 illustrates an example computing device capable of processing one or more tasks simultaneously.

FIG. 2 is a flow diagram illustrating an embodiment of a procedure for initializing a system having multiple devices coupled to one another.

FIG. 3 is a flow diagram illustrating an embodiment of a procedure for migrating tasks between various devices.

FIGS. 4A-4D illustrate a sequence of four bipartite graphs.

FIG. 5 illustrates an example general computer environment, which can be used to implement the techniques described herein.

### DETAILED DESCRIPTION

The systems and methods described herein assign tasks to computing devices in a manner that reduces the number of task migrations among computing devices while, at the same time, hosting as many tasks as possible at a particular time. The described systems and methods predict the movement of objects, data, tasks, or other items to determine the future location and/or needs of the tracked item(s).

A particular example discussed herein provides a vehicle tracing system that monitors the movement of a vehicle in a parking garage. Other example environments that may implement the described systems and methods include monitoring objects or people in a warehouse, storing data on multiple data servers, distributing tasks among multiple processors, and providing services to mobile users (e.g., moving data to different devices based on the predicted movement of the mobile users).

As discussed herein, a task is an abstraction of a computational agent or a piece of data that is hosted by a device (such as a microserver or other computing device). When assigning tasks (or reassigning tasks) among multiple devices, object motion can be an important consideration in making those assignments. For example, object motion causes different motion sensors to observe the object at different times. In this example, tasks may be assigned and reassigned as the object moves out of one sensor's range and into another sensor's range. Furthermore, communication, processing, or memory constraints may allow certain sensors to monitor a limited number of objects at the same time. In these situations, it is beneficial to assign tasks in a manner that minimizes the number of migrations (e.g., movements of tasks from one device to another), and thus be kinetically stable. At the same time, it is beneficial to monitor as many tasks as possible at a particular time.

When task trajectories are known in advance, a particular algorithm is used to handle task assignment and reassignment. When only probabilistic information about future movement of the tasks is known, two different algorithms may be used: a multi-commodity flow based algorithm and a maximum matching algorithm. These two algorithms are discussed in detail below.

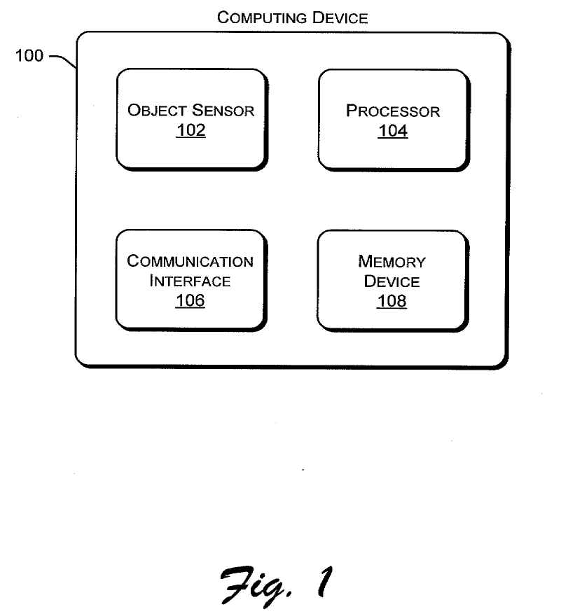

FIG. 1 illustrates an example computing device 100 capable of processing one or more tasks simultaneously. In certain embodiments, computing device 100 is referred to as a “microserver”, a “device”, a “sensor”, a “monitor”, or a “node”. Computing device 100 includes an object sensor 102 which is capable of sensing the position and/or direction of one or more objects (such as vehicles, people, packages, containers, and the like). Computing device 100 also includes at least one processor 104 that is capable of performing at least one task. In particular embodiments, processor 104 is capable of performing multiple tasks simultaneously.

Additionally, computing device 100 includes at least one communication interface 106, which is capable of communicating with any number of different devices. Communication interface 106 can communicate via any wired or wireless communication medium using any communication protocol. Computing device 100 also includes a memory device 108 that stores various data, such as algorithms, task-related data, and data captured by object sensor 102. Memory device 108 may contain one or more volatile and/or non-volatile memory elements that store data.

In a particular embodiment, computing device 100 is a resource-constrained device that is coupled to multiple other similar devices to form a network of resource-constrained devices. Computing device 100 may be constrained in the area of communication (e.g., limited bandwidth), processing (e.g., limited processing resources), or memory (e.g., limited memory storage capacity). Computing device 100 may also be constrained by its ability to host a limited number of tasks at a time. Additionally, due to physical or system dynamics (such as the motion of objects to be monitored or the motion of data consumers), the computing devices that can host a particular task change over time.

As discussed further below, tasks can be migrated (e.g., assigned or reassigned) among multiple computing devices 100 for continuous execution. However, this migration of tasks has associated costs, such as energy consumption and deterioration of quality of service. Energy consumption may be particularly important in computing devices that operate on batteries. These limitations present a dynamic resource allocation problem (e.g., determining which computing devices will host particular tasks). The systems and methods discussed herein assign and reassign tasks to computing devices in a manner that reduces the number of task migrations, and thus be kinetically stable. At the same time, these systems and methods hosting as many tasks as possible at a particular time.

A particular example discussed herein is related to a system that tracks vehicles in a parking garage. The parking garage contains multiple camera sensors, each of which is coupled to or contained in a computing device. The cameras can pan and tilt to focus on specific areas of the parking garage. Each camera has a limited field of view. The fields of view for two or more cameras may overlap, such that multiple cameras can view the same region. Vehicle motion within the parking garage is somewhat predictable—there are driveway constraints in the parking garage as well as traffic patterns at various times of the day that are known (e.g., vehicles entering the garage in the morning and leaving the garage in the evening).

In one embodiment, the multiple computing devices coupled to the multiple cameras communicate with one another and with a central server via a data communication network. In this example, a task is a video signal processing agent that can estimate the location of the vehicles it observes. Due to the signal processing load, each computing device can host a limited number of tracking tasks at a time.

When a vehicle performs a small movement, the tracking camera can pan or tilt to follow the vehicle. Eventually, the vehicle may move out of one camera's field of view and needs to be tracked by another camera. Due to the design of the tracking algorithm in this example, using the same camera to track a vehicle is easier than switching to another camera. Switching cameras requires re-detecting the vehicle from a different viewing angle, which may degrade the tracking performance. When conflicts occur among multiple resource requests, the video data may be sent to a central server for processing. However, such data transmission is subject to bandwidth limitations of the system.

As mentioned above, the systems and methods discussed herein attempt to reduce the number of task migrations (e.g., the reduction in the number of vehicle re-detections and task transfers between computing devices). Although some task migration is necessary to follow moving vehicles in the parking garage, the described systems and methods attempt to avoid unnecessary task migrations.

In addition to tracking moving vehicles, the migration of tasks and/or data among multiple computing devices arises in many other situations. For example, in a setting where the users are mobile and operating in the same space as the sensors, it may be desirable to migrate data of potential interest toward nodes near particular users so that the data is always available to the particular users with low latency. This type of migrating information cache may be useful with mobile telephone systems, location awareness systems, and search-and-rescue operations.

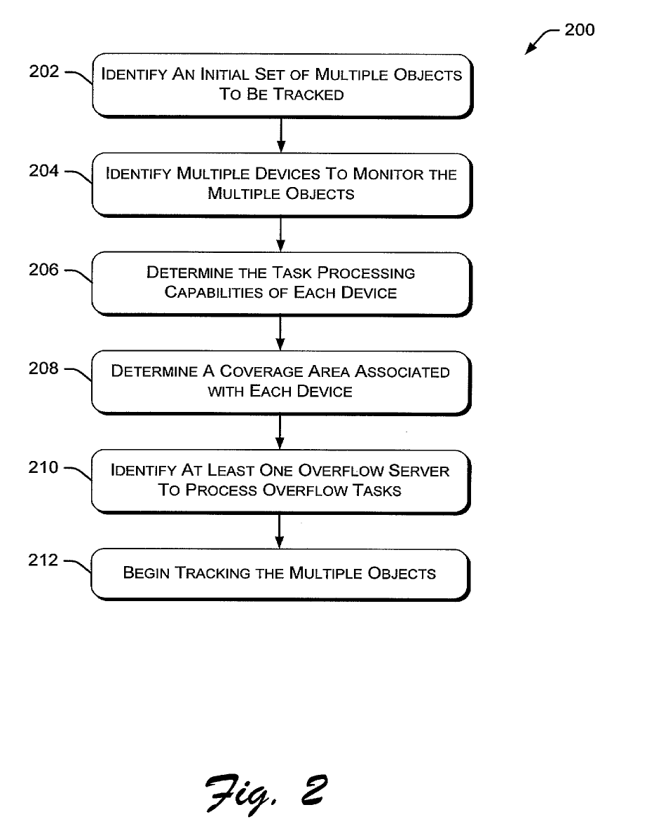

FIG. 2 is a flow diagram illustrating an embodiment of a procedure 200 for initializing a system having multiple devices coupled to one another. Procedure 200 begins by identifying an initial set of multiple objects to be tracked (block 202). The tracked objects may be vehicles, people, products, containers, and the like. Although block 202 identifies an initial set of multiple objects to track, new objects may be added to the system at any time and existing objects may be terminated at any time.

The procedure then identifies multiple devices (e.g., sensors or cameras coupled to a computing device) to monitor the multiple objects (block 204). Procedure 200 continues by determining the task processing capabilities of each device (block 206) and determining a coverage area associated with each device (block 208). Additionally, the procedure identifies at least one overflow server to process overflow tasks (block 210), such as tasks that cannot be processed by the multiple devices. Finally, the procedure begins tracking multiple objects using the multiple devices (block 212).

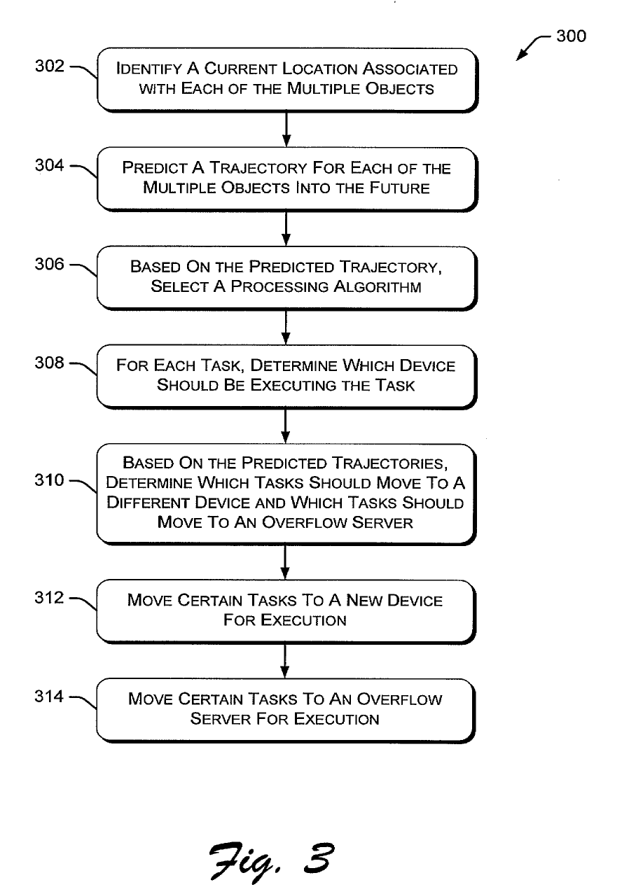

FIG. 3 is a flow diagram illustrating an embodiment of a procedure 300 for migrating tasks between various devices. Initially, procedure 300 identifies a current location associated with each of the multiple objects (block 302). The procedure then predicts a trajectory for each object up to a certain time into the future (block 304). Based on one or more predicted trajectories, the process selects a processing algorithm (block 306). Additional details regarding selection of a processing algorithm are provided below.

For each task, the procedure determines which device should be executing the task (block 308). Based on the predicted trajectories, the procedure then determines which tasks (if any) should move to a different device and which tasks (if any) should move to an overflow server (block 310). Based on this determination, procedure 300 moves certain tasks to a new device for execution (block 312) and moves certain tasks to an overflow server for execution (block 314).

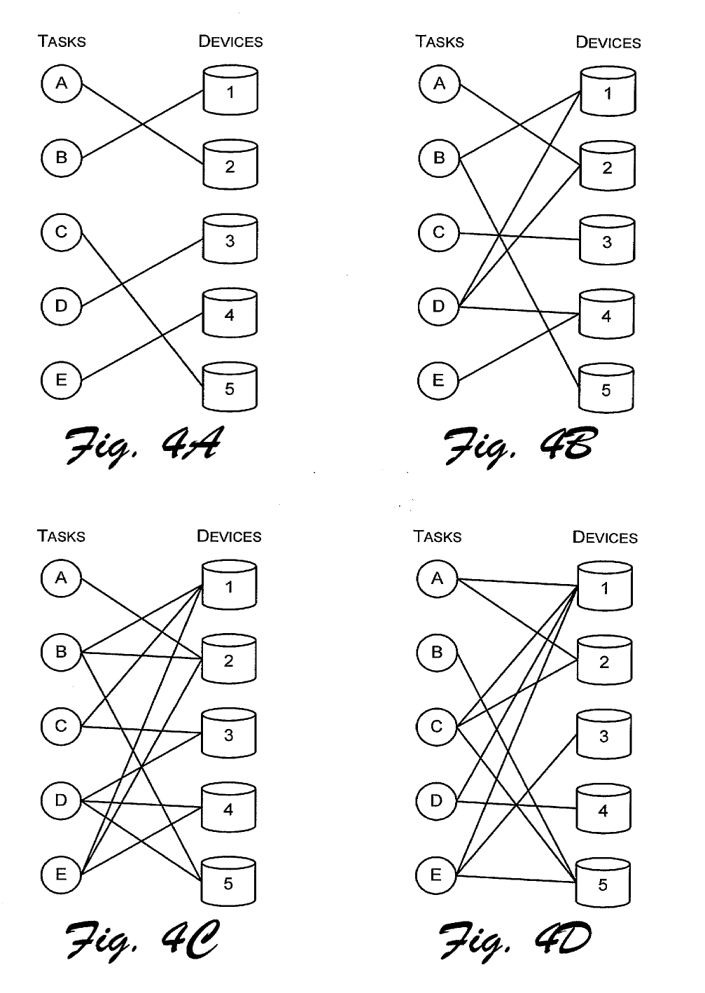

In one embodiment, an algorithm determines which tasks should move to a different device or to an overflow server for execution. This algorithm is referred to as a kinetically stable task assignment algorithm. For purposes of this algorithm, task allocations are associated with discrete time steps indexed by integers t=1, 2, . . . T. “N” is the set of multiple devices and “K” is the set of multiple tasks. There is also an N length vector cap, where cap(i) equals the capacity of device i. At each time step t there is a bipartite graph B^{t}=(K, N, E^{t}) where E^{t}={(u, v) | task u can be hosted by device v at time t}. A sequence of bipartite graphs is illustrated in FIGS. 4A-4D. Bipartite graphs have vertices that can be divided into two separate sets where two vertices of the same set do not share an edge. FIG. 4A is associated with time t=0, FIG. 4B is associated with time t=1, FIG. 4C is associated with time t=2, and FIG. 4D is associated with time t=3.

When assigning tasks to devices and/or servers, the algorithm attempts to produce a maximum matching for each time step, avoid assigning more tasks than a device or server can process, and assign tasks in a stable manner. Regarding the maximum matching for each time step, if it is not possible to cover all tasks at a particular time step, the algorithm attempts to cover as many tasks as possible, regardless of the number of migrations. For example, if there is an option to cover all tasks, but all tasks must migrate, this solution is preferable to covering less than all tasks without any migration. The algorithm also avoids assigning more tasks than a device or server can process. For example, device i is assigned no more than cap (i) tasks at each time step. The stability of an assignment is measured by the sum over all tasks of the number of times a task has to be switched to a new device during a period of task motions. The number of migrations at time step t is the number of edges in the matching for B^{t} that do not exist in the matching for B^{t-1}. The algorithm attempts to produce a matching for all the bipartite graphs such that the total number of migrations from time zero until time T is reduced or minimized.

As mentioned above, procedure 300 selects a specific processing algorithm based on one or more predicted trajectories (block 306). In a particular embodiment, three processing algorithms are available for assigning tasks to devices. Procedure 300 selects a first algorithm when the future trajectory of an object is known with complete certainty. Procedure 300 selects a second algorithm when the future trajectory of an object is not known with complete certainty, but the probability of each possible trajectory can be calculated with a reasonable degree of certainty. Finally, procedure 300 selects a third algorithm when the future trajectory of an object is not known and cannot be reasonably predicted. A threshold is used for choosing between the second and third algorithms. This threshold is a system design parameter. In one embodiment, the threshold is set at 90%, indicating a 90% probability that one particular trajectory will be taken by the object.

Different algorithms may be used with different objects. For example, the first algorithm is used to process object A while the second algorithm is used to process object B. Additionally, different algorithms may be used with the same object at different times. For example, at one point in time the first algorithm is used to process object A. At a future point in time, the second or third algorithm is used to process object A. This change in algorithm may be based on movement of object A such that the possible trajectory of object A is more or less definite.

All three algorithms use the same linear program (shown below), but each algorithm uses a different formula for calculating the components of the linear program. The linear program is written:

$$min {\sum }_{kijt} {C}_{ijt}^{k} {X}_{ijt}^{k}$$

The linear program uses non-negative variables χᵢⱼₜ^{k} to indicate whether or not task k is moved from device i to device j at time step t. If the time is zero (or T), then the source (or sink) is considered the device for that time step. In the first algorithm mentioned above (i.e., when the future trajectory of an object is known with complete certainty), the cost of migrating task k from device iεN at time step t to device jεN at time step t+1 is denoted Cᵢⱼₜ^{k}. The variable Cᵢⱼₜ^{k} is set to 0 if i=j or if either i or j is the source or sink. Otherwise, the cost is set to 1. An emergency node (also referred to as an overflow server) is used if a complete matching does not exist. The cost of using the emergency node is set to be prohibitively expensive, ensuring a maximum matching is chosen at every time step. The system sets the value of variable x to zero if task k cannot be monitored by device j at time t.

In a particular embodiment, several constraints are placed on the linear program presented above. First, tasks are assigned to devices such that no device exceeds its task-handling capacity. Additionally, the number of tasks being processed remains constant (i.e., existing tasks are not deleted and new tasks are not added). Finally, at time t=0, each task exists on one device in the system.

The second algorithm discussed above is used when the future trajectory of an object is not known with complete certainty, but the probability of each possible trajectory can be calculated with a reasonable degree of certainty. This algorithm calculates the cost of migration as shown below. Given a current time t, the system finds a matching for the bipartite graph B^{t}=(K, N, E^{t}) and the bipartite graphs for all future time steps. The value of the matching is the time-discounted number of migrations within a time window plus the time discounted likelihood that the matching will be possible.

In this situation, pr(k, j, t) is the probability that task k can be assigned to device j at time t. Additionally, 0<β<1 is a time discounting factor and C is a predefined constant. Time discounting indicates that migrations in the near future are more costly than those in the distant future. The following equation is used in the second algorithm:

$${C}_{ijt}^{k} = \begin{matrix}1000 * K * T & if j is emergency node \\ ( - log ( pr ( k , j , t ) - ε ) ) ( {β}^{t} ) & if j = i \\ ( C + ( - log ( pr ( k , j , t ) - ε ) ) ( {β}^{t} ) & otherwise\end{matrix}$$

For the above function, consider that each task is an agent working on its own behalf with no concern for the constraints of the overall system (i.e., the device capacities). The probability that a task will choose a given trajectory is the product of probabilities that the choice was available and that it was the best option at that time. Taking the log gives the sum of migrations that occur plus the sum of the log of probabilities along that edge. The function is trying to let as many tasks choose as they want, subject to the capacities of the devices.

The third algorithm discussed above is used when the future trajectory of an object is not known and cannot be reasonably predicted. This algorithm calculates the cost of migration as shown below. In this situation, given a current time t, the system finds a maximum matching of minimum cost for the bipartite graph B^{t}=(K, N, E^{t}) where the cost of an edge k, n in this matching is:

$$\begin{matrix}{C}_{n}^{k} = & 1000 * K * T & if n is the emergency node \\ & - {\sum }_{t = 1}^{T} ( {β}^{t} ) pr ( k , n , t ) & otherwise\end{matrix}$$

In the examples discussed herein, time synchronization is available for the devices and the necessary data for computing device assignment is quickly routed through the devices. In particular, a routing protocol is used to communicate data from sensor nodes to associated devices. Source interference is resolved at the device or the server level such that source separation is not a problem. Certain processes can predict (with some uncertainty) the motion or evolution of the object of interest. When analyzing a possible migration, the cost of the migration is considered fixed.

In one embodiment, the future trajectories of objects are fully known. This embodiment is referred to as a deterministic kinetically stable task assignment embodiment. In this embodiment, the bipartite graphs associated with future time steps are known with certainty, as is the bipartite graph associated with the current time step (e.g., time t=1) and the bipartite graph associated with the previous time step (e.g., time t=0). Multiple different linear programming solutions may be used to implement this embodiment. In a particular implementation, the SIMPLEX family of linear programming solutions is used, such as a software package “CPLEX” from ILOG Inc.

In another embodiment, the future trajectories of objects are not fully known. This embodiment is referred to as a probabilistic kinetically stable task assignment embodiment. In this embodiment, the previous assignment and probabilistic information about future movement of the objects is used to minimize the expected number of task migrations between devices. The probabilistic information is based on predicted movement of the objects based on previous object movements and available paths in which the objects can move.

When assigning (or reassigning) tasks, the current situation is defined by a set of locations P, a set of tasks K, and a set of computing devices N. The number of time steps that tasks will have to be monitored in the future is denoted T. The time window W is the number of time steps in the future that the algorithm considers when determining its matching in the current time step. In one example, Markov chains are used to represent the probabilistic information known about task movement. A Markov chain describes the states of a system at successive times. There is a state for each discrete location where a task can be placed, and a transition probability from state s to s′ represents the probability that the task will move to the location that corresponds with state s′ in the next time step, given that it is located at the location that corresponds to state s in the current time step. There is a separate transition matrix defined for each task, but the set of states over which the transition matrix is defined is consistent between tasks. There is a P by P matrix M for every task k such that Mₖ(i, j) is the probability that task k moves to location i in the next time step if it is at location j in the current time step.

Each computing device covers some subset of locations and is able to monitor any task at a location it covers. The computing device coverage is represented with a P by N matrix C such that C(i, j)=1 if computing device j covers location i, and equals zero otherwise.

Each computing device has a capacity limiting the number of tasks it can monitor in a single time step. The capacity values are stored in an N length vector cap, where cap(i) equals the capacity of computing device i. The actual trajectory taken by each task is held in a P by K by T matrix J where J(i, j, t)=1 if task j is located at location i at time t.

An algorithm for the task assignment problem will determine an assignment of tasks to computing devices at each of several time steps. The algorithm is provided with time invariant input: M, cap, C, and T. In general, M can vary at each time instance. Other inputs may be fixed or may change as the algorithm is executed.

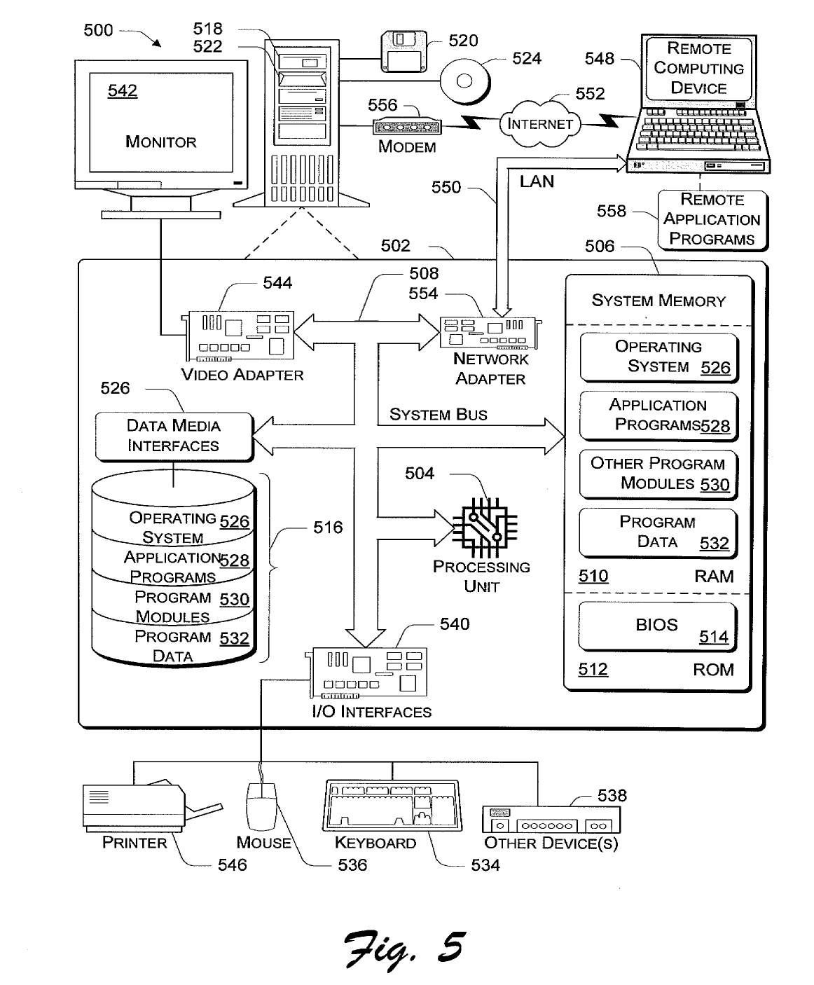

FIG. 5 illustrates an example general computer environment 500, which can be used to implement the techniques described herein. The computer environment 500 is only one example of a computing environment and is not intended to suggest any limitation as to the scope of use or functionality of the computer and network architectures. Neither should the computer environment 500 be interpreted as having any dependency or requirement relating to any one or combination of components illustrated in the example computer environment 500.

Computer environment 500 includes a general-purpose computing device in the form of a computer 502. Computer 502 can be, for example, a desktop computer, a handheld computer, a notebook or laptop computer, a server computer, a game console, and so on. The components of computer 502 can include, but are not limited to, one or more processors or processing units 504, a system memory 506, and a system bus 508 that couples various system components including the processor 504 to the system memory 506.

The system bus 508 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 502 typically includes a variety of computer readable media. Such media can be any available media that is accessible by computer 502 and includes both volatile and non-volatile media, removable and non-removable media.

The system memory 506 includes computer readable media in the form of volatile memory, such as random access memory (RAM) 510, and/or non-volatile memory, such as read only memory (ROM) 512. A basic input/output system (BIOS) 514, containing the basic routines that help to transfer information between elements within computer 502, such as during start-up, is stored in ROM 512. RAM 510 typically contains data and/or program modules that are immediately accessible to and/or presently operated on by the processing unit 504.

Computer 502 may also include other removable/non-removable, volatile/non-volatile computer storage media. By way of example, FIG. 5 illustrates a hard disk drive 516 for reading from and writing to a non-removable, non-volatile magnetic media (not shown), a magnetic disk drive 518 for reading from and writing to a removable, non-volatile magnetic disk 520 (e.g., a “floppy disk”), and an optical disk drive 522 for reading from and/or writing to a removable, non-volatile optical disk 524 such as a CD-ROM, DVD-ROM, or other optical media. The hard disk drive 516, magnetic disk drive 518, and optical disk drive 522 are each connected to the system bus 508 by one or more data media interfaces 526. Alternatively, the hard disk drive 516, magnetic disk drive 518, and optical disk drive 522 can be connected to the system bus 508 by one or more interfaces (not shown).

The disk drives and their associated computer-readable media provide non-volatile storage of computer readable instructions, data structures, program modules, and other data for computer 502. Although the example illustrates a hard disk 516, a removable magnetic disk 520, and a removable optical disk 524, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 516, magnetic disk 520, optical disk 524, ROM 512, and/or RAM 510, including by way of example, an operating system 526, one or more application programs 528, other program modules 530, and program data 532. Each of such operating system 526, one or more application programs 528, other program modules 530, and program data 532 (or some combination thereof) may implement all or part of the resident components that support the distributed file system.

A user can enter commands and information into computer 502 via input devices such as a keyboard 534 and a pointing device 536 (e.g., a “mouse”). Other input devices 538 (not shown specifically) may include a microphone, joystick, game pad, satellite dish, serial port, scanner, and/or the like. These and other input devices are connected to the processing unit 504 via input/output interfaces 540 that are coupled to the system bus 508, but may be connected by other interface and bus structures, such as a parallel port, game port, or a universal serial bus (USB).

A monitor 542 or other type of display device can also be connected to the system bus 508 via an interface, such as a video adapter 544. In addition to the monitor 542, other output peripheral devices can include components such as speakers (not shown) and a printer 546 which can be connected to computer 502 via the input/output interfaces 540.

Computer 502 can operate in a networked environment using logical connections to one or more remote computers, such as a remote computing device 548. By way of example, the remote computing device 548 can be a personal computer, portable computer, a server, a router, a network computer, a peer device or other common network node, and the like. The remote computing device 548 is illustrated as a portable computer that can include many or all of the elements and features described herein relative to computer 502.

Logical connections between computer 502 and the remote computer 548 are depicted as a local area network (LAN) 550 and a general wide area network (WAN) 552. Such networking environments are commonplace in offices, enterprise-wide computer networks, intranets, and the Internet.

When implemented in a LAN networking environment, the computer 502 is connected to a local network 550 via a network interface or adapter 554. When implemented in a WAN networking environment, the computer 502 typically includes a modem 556 or other means for establishing communications over the wide network 552. The modem 556, which can be internal or external to computer 502, can be connected to the system bus 508 via the input/output interfaces 540 or other appropriate mechanisms. It is to be appreciated that the illustrated network connections are exemplary and that other means of establishing communication link(s) between the computers 502 and 548 can be employed.

In a networked environment, such as that illustrated with computing environment 500, program modules depicted relative to the computer 502, or portions thereof, may be stored in a remote memory storage device. By way of example, remote application programs 558 reside on a memory device of remote computer 548. For purposes of illustration, application programs and other executable program components such as the operating system are illustrated herein as discrete blocks, although it is recognized that such programs and components reside at various times in different storage components of the computing device 502, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Alternatively, portions of the framework may be implemented in hardware or a combination of hardware, software, and/or firmware. For example, one or more application specific integrated circuits (ASICs) or programmable logic devices (PLDs) could be designed or programmed to implement one or more portions of the framework.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
identifying multiple objects to be monitored;
identifying multiple devices to monitor the multiple objects;
identifying multiple tasks to be executed by the multiple devices;
predicting a trajectory for each object; and
determining which device should be executing each of the multiple tasks based on the predicted trajectory for each object.

2. A method as recited in claim 1 further comprising identifying at least one overflow server associated with the multiple devices, the overflow server to process overflow tasks.

3. A method as recited in claim 1 further comprising determining a task Processing capability associated with each device.

4. A method as recited in claim 1 further comprising determining a coverage area associated with each device.

5. A method as recited in claim 1 further comprising moving at least one task to a different device for execution.

6. A method as recited in claim 1 further comprising moving at least one task to an overflow server for execution.

7. A method as recited in claim 1 further comprising identifying a current location associated with each of the multiple objects.

8. A method as recited in claim 1 further comprising determining a number of time steps that the multiple objects will be monitored in the future.

9. A method as recited in claim 1 further comprising generating a Markov chain to represent probabilistic information known about movement of the multiple tasks.

10. A method as recited in claim 1 further comprising determining an allocation of the multiple tasks among the multiple devices for a next time step.

11. An apparatus comprising:
a memory device to store data; and
a processor coupled to the memory device, the processor to identify multiple processes to be monitored and to identify multiple systems to execute the multiple processes, the processor further to predict future reassignment of a portion of the multiple processes to different systems, and wherein the processor further determines which processes should currently be reassigned to different systems.

12. An apparatus as recited in claim 11, the processor further to determine which processes should be reassigned to an overflow server coupled to the apparatus.

13. An apparatus as recited in claim 11, the processor further to determine a process handling capacity associated with each of the multiple systems.

14. An apparatus as recited in claim 11, the processor further to determine a number of time steps that the multiple processes will be monitored in the future.

15. An apparatus as recited in claim 11, the processor further to store information in the memory device regarding a current allocation of the multiple processes among the multiple systems.

16. An apparatus as recited in claim 11, the processor further to transfer at least one process to a different system for execution.

17. A method comprising:
identifying multiple processes to be monitored;
identifying multiple devices to monitor the multiple processes;
identifying multiple tasks to be executed by the multiple devices;
determining which device should execute each of the multiple tasks; and
assigning each of the multiple tasks to a particular device.

18. A method as recited in claim 17, wherein determining which device should execute each of the multiple tasks includes predicting a future reassignment of the multiple tasks.

19. A method as recited in claim 17, further comprising transferring at least one of the multiple tasks to a different device for execution.

20. A method as recited in claim 17, further comprising determining a task processing capability associated with each device.
